(19) United States
(12) Patent Application Publication
(10) Pub. No.: US 2026/0117038 A1
(43) Pub. Date: Apr. 30, 2026

(54) Process for Removing Polyurethane Fibers from Polyamide Articles

(71) Applicant: Rhodia Brasil S.A., Sao Paulo (BR)

(72) Inventors: Fernanda Hoelscher, Paulinia (BR); Luiza Tavares Gamba, Santo Andre (BR); Guainumbi Veloso Medeiros, Paulinia (BR); Pierre Hansu Pak, Santo Andre (BR); Felipe Vidoto Dutra, Apucarana PR (BR); Marcos Henrique De Souza Santana, Apucarana PR (BR); Joyce Gabriella Dias Dutra, Apucarana PR (BR)

(21) Appl. No.: 19/152,127

(22) PCT Filed: Nov. 8, 2024
(86) PCT No.: PCT/IB2024/061103

§ 371 Date: Jul. 30, 2025

(30) Foreign Application Priority Data
Nov. 8, 2023 (WO) PCT/IB2023/061287

(51) Int. Cl. C08J 11/16; C08J 11/24

(52) U.S. Cl. CPC C08J 11/16; C08J 11/24; C08J 2375/04; C08J 2477/00

(57) ABSTRACT

Provided herein is a process for removing polyurethane fibers from a polyamide article, included at least one step of depolymerization of the polyurethane fibers carried out by contacting said article with at least one solvent.

### CROSS-REFERENCE TO RELATED APPLICATIONS

This application is the United States national phase of International Patent Application No. PCT/IB2024/061103 filed Nov. 8, 2024, and claims priority to International Patent Application No. PCT/IB2023/061287 filed Nov. 8, 2023, the disclosures of which are hereby incorporated by reference in their entireties.

### BACKGROUND OF THE INVENTION

### Field of the Invention

The present invention is related to a process for removing polyurethane fibers from polyamide articles comprising depolymerization of polyurethane fibers from the polyamide article using at least one solvent.

Textile industry accounts for a considerable proportion of the amount of waste, in particular through the use of fiber mixtures for clothing.

Polyamide is one of the most important fibers in both textile industry and industrial materials, and the most important of all in combination with polyurethane and other natural fibers in a variety of clothing articles.

However, unlike natural polymers such as wool, cotton, silk and viscose which are degradable and can be reclassified into the natural cycle, man-made fibers and films, such as polyamides, polyurethane, are largely microbial resistant.

### Description of Related Art

There are some recycling processes developed to recover polyamide from materials containing a combination of polyamide and polyurethane.

For example, JP2008031127 discloses a method for chemically recycling nylon fibers processed with polyurethane, basically consisting in a heat treatment of the polyurethane-processed nylon fibers in an organic solvent to remove the polyurethane by elution followed by the depolymerization of the nylon fibers to recover a lactam.

Such a process may be possibly appropriate for the removal of polyurethane that has been applied on the surface of a polyamide fabric, for example to impart moisture-permeable waterproof properties to the fabric. But it is not suitable for other types of polyamide fabrics wherein polyurethane is evenly distributed in the polyamide fabric.

Also, WO2013032408 discloses a method of polyamide fiber recycling from elastomeric fabrics, by controlled thermal degradation and wash separation of spandex from fabric or garments containing polyamide fiber. Thermal degradation changes the structure of spandex into short soft fibers and particulate sections that is removed.

However, the described thermal degradation involves a process having a challenging industrial application using autoclave and controlled atmosphere.

Despite advances in technologies for recycling polyamide articles, there is a need to develop a scalable recycling process capable of removing polyurethane fibers blended with polyamide fibers in a polymeric material, notably a clothing or fabric.

Pursuing its research in this field, the Applicant has now discovered an original and very simple recycling polyamide fabric process able to remove polyurethane fibers blended to polyamide fibers using a selective depolymerization strategy that targets polyurethane fibers, while keeping polyamide fibers intact.

### SUMMARY OF THE INVENTION

The first object of the present invention is, therefore, to provide a process for removing polyurethane fibers from a polyamide article, comprising at least one step of depolymerization of the polyurethane fibers carried out by contacting said article with at least one solvent.

The polyamide article to be subjected to this process may contain dyes or not. The presence of dyes in polyamide articles is known to hinder the recycling performances of most of the known polyamide recycling processes. Advantageously, it was nevertheless possible to achieve good results in terms of polyurethane removal rate and in terms of dyes removal rate when implementing a process according to the invention.

Accordingly, the invention also relates to a process for removing polyurethane fibers and dyes from a polyamide article, comprising at least one step of depolymerization of the polyurethane fibers carried out by contacting said article with at least one solvent.

The term “contacting” denotes in the framework of the present invention any suitable method to put into contact the polyamide article containing the polyurethane fibers with the at least one solvent, as long as it results, at least partially, in a depolymerization of the polyurethane fibers contained in the polyamide article. For instance, the contact there between can be made by impregnating the polyamide article containing the polyurethane fibers with the solvent, more particularly by immersing said article in a bath comprising or consisting of the solvent, by spraying the solvent onto or injecting the solvent into said article.

Indeed, it was found that the process of the present invention provides a selective removal of the polyurethane fibers from a polyamide article, even when said fibers are intimately blended to the polyamide fibers in the article. The process of the invention enables the recovery of the polyamide in high yield, and in in high purity. Additionally, the process of the invention avoids the degradation of both polyamide and polyurethane during the separation process, enabling recycling of both polymers separately. Finally, when dyes are additionally present in the polyamide article to be treated, the process of the invention has the further advantage of quantitatively removing said dyes.

The present invention also relates to a detailed process for removing polyurethane fibers from a polyamide article, comprising at least the following steps:
a1. providing a polyamide article comprising polyurethane fibers and, optionally, dyes, and optionally pre-washing said article by contacting it with a solution comprising water and at least one surfactant;
a2. submitting the optionally pre-washed polyamide article to at least one polyurethane fiber depolymerization process comprising at least one step of 20 contacting said article with at least one solvent, and;
a3. post-washing the polyamide article from step a2 by contacting said article with a solution comprising at least one solvent selected from aliphatic alcohols containing C1-C3 carbon chain or a glycerol ketal or a combination of water and at least one surfactant to remove the depolymerized polyurethane fibers.

Advantageously, the process developed by the present invention allows not only the effective removal of polyurethane fibers from polyamide articles containing polyurethane fibers in a simple and scalable process, but also removal of dyes from the article and the recovery and reuse of solvents and catalyst during the different steps of the process, making it friendlier to the environment.

Notably, the amount (in weight) of polyurethane fibers removed from the polyamide article recovered from step a3 can be of at least 87%, relatively to the amount (in weight) of polyurethane fibers in the polyamide article initially provided in step a1.

In the presence of dyes in the polyamide article provided in step a1, the amount (in weight of polyamide fibers) of dyes removed from the polyamide article recovered from step a3 can noteworthy be of at least 60 wt %, in particular of at least 75 wt %, relatively to the amount (in weight of polyamide fibers) of dyes in the polyamide article initially provided in step a1.

In the absence of dyes in the polyamide article provided in step a1, the amount (in weight) of polyurethane fibers removed from the polyamide article recovered from step a3 can even reach at least 90 wt %, in particular at least 93 wt %, more particularly at least 95 wt %, relatively to the amount (in weight) of polyurethane fibers in the polyamide article initially provided in step a1.

Other subjects, characteristics, aspects and advantages of the invention will emerge even more clearly on reading the description and the examples that follow.

In the present description, and unless otherwise indicated:
the expression “at least one” is equivalent to the expression “one or more” and can be replaced therewith;
the expression “comprising” is equivalent to the expression “containing”.
the expression “weight percent,” “wt %,” “percent by weight,” “% by weight,” and variations thereof refer to the concentration of a substance as the weight of that substance divided by the total weight of the composition and multiplied by 100.
the term “polyamide article” in the sense of the invention is a transformed or treated polyamide fiber blended to polyurethane fiber and includes staple fibers, any flock or any textile composition made of combination of fibers, with major content of polyamide, especially fabrics and/or clothing. In the below description, the terms “fiber”, “yarn” and “filament” can be used indifferently without changing the meaning of the invention.
the term “blended” as used herein, should be understood as synonyms and related to different materials that are joined together, such as polyamide fibers and polyurethane fibers, intertwined together in the fabric structure, or intermingled together in the yarn structure.

Throughout the description, including the claims, all process terms should be understood as being synonymous with the term method.

### DESCRIPTION OF THE INVENTION

The present invention relates to a process for removing polyurethane fibers from a polyamide article comprising at least one step of depolymerization of the polyurethane fibers contained in the polyamide article also called “depolymerization step”, which is carried out by contacting said polyamide article containing the polyurethane fibers with at least one solvent.

Typically, the polyamide article according to the invention comprises advantageously from 5-30% by weight of polyurethane fibers, preferably from 5-21% by weight, based on the total weight of the polyamide article.

Preferably, the depolymerization step of the polyurethane fibers is carried out in the presence of at least one catalyst.

In one embodiment, the catalyst is selected from compounds capable of generating a free hydroxide (OH⁻) or alkoxide (RO⁻) or proton (H⁺) in the reaction medium. In a more specific embodiment, the catalyst is selected from hydroxy base compounds and acids. In a more particular embodiment, the catalyst is selected from hydroxy base compounds.

In a preferred embodiment, the catalyst is selected from sodium hydroxide, potassium hydroxide, solid bases, phosphoric acid, boric acid, sulfuric acid, organic acids, organic sulfonic acids, solid acids, and salts thereof.

In another preferred embodiment, the catalyst is a base selected from sodium hydroxide, potassium hydroxide and mixtures thereof.

In a particular preferred embodiment, the catalyst is a base consisting of sodium hydroxide.

As mentioned previously, the process of the invention uses at least one solvent to depolymerize the polyurethane fibers contained in the polyamide article to be treated.

Advantageously, the solvent used in the process is not only reusable but also environment-friendly.

The solvents preferably used according to the invention have very good performance in the application, low odor and no toxicity to humans or environment.

In one embodiment, the solvent is a polar solvent selected from aliphatic alcohols containing C1-C3 carbon chain or a glycerol ketal selected from solketal, 2-isobutyl-2-methyl-1,3-dioxolane-4-methanol; 2,2-dimethyl-1,3-dioxolane-4-acetate; 2,2-diisobutyl-1,3-dioxolane-4-methanol or mixtures thereof.

The above mentioned glycerol ketal solvents have good solubilization properties, good physical-chemical properties, low odor and good HSE (Health, Safety and Environment) profile. They also have the advantage of not being derived from petrochemical sources.

Preferably, the solvent is ethanol or solketal.

Preferably, the solvent is a compound according to the following formula I:

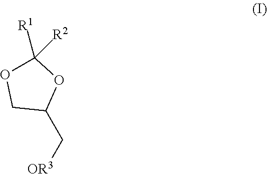

wherein R¹ and R², independently from one another, are selected in the group consisting of: linear or branched C1-C12 alkyl, a C4-C12 cycloalkyl or an aryl (in particular, a C6-C12 aryl); R³ is H, a linear or branched alkyl (in particular, a linear or branched C1-C12 alkyl), a cycloalkyl (in particular, a C4-C12 cycloalkyl) or a —C(═O)R⁴ group, with R⁴ being a linear or branched alkyl (in particular, a linear or branched C1-C12 alkyl) or cycloalkyl (in particular, a C4-C12 cycloalkyl).

In a preferred embodiment R¹ and R² are methyl and R³ is H. In this case, the compound is commercially available, for example under the name Augeo® Clean Multi (in the following “ACM”) or Solketal. This compound can be synthesized by reaction between glycerol and acetone under conditions known in the art.

Particularly, solketal is a solvent commercially available, for example under the name Augeo® Clean Multi or Augeo® SL191 by Solvay.

According to one embodiment, the process according to the present invention, is particularly effective when the contact of the polyamide article with the solvent is performed by having greater amount of solvent in comparison with the polyamide article amount. In particular, the solvent may be used in the form of a bath in which the polyamide article is immersed; the amount of solvent is preferably chosen so as to cover the polyamide article, preferably without letting any part of the polyamide article uncovered with the solvent.

In a preferred embodiment, the ratio of polyamide article:solvent ranges from 1:5 to 1:100, preferably from 1:30 to 1:10, in terms of article mass in kg to solvent volume in L.

According to one embodiment, the depolymerization step is carried out in presence of at least one catalyst.

It was discovered that the use of a combination of a solvent and a catalyst, advantageously in mild conditions, allows recovery of high purity polyamide fibers by selective depolymerization of polyurethane fibers from articles or fabrics containing polyamide and polyurethane fibers blended together.

In one embodiment, the depolymerization step is performed at a temperature above 80° C., preferably above 95° C. It may range, notably from 80° C. to 150° C., in particular from 80° C. to 130° C., more particularly from 80° C. to 110° C.

The polyamide article according to the invention can be transformed into different articles, notably a textile fabric and/or clothing. A polyamide article according to the invention is preferably polyamide and polyurethane textiles, yarns and fibers made with major content of polyamide fibers blended to minor content of polyurethane fibers, notably in the proportions defined above.

The methods for transforming the polyamide and polyurethane fibers into a polyamide article like a textile fabric or clothing are well known by the skilled person in the art. Indeed, the polyamide and polyurethane fibers can be transformed into a polyamide article by texturizing, drawing, warping, knitting, weaving, nonwoven processing, garment manufacturing or a combination thereof. These articles are subsequently used in a large number of applications, in particular in hosiery, underwear, sportswear, outerwear and leisurewear.

Indeed, the polyamide and polyurethane fibers according to the invention can contain other additives like plasticizers, antioxidants, stabilizers such as heat or light stabilizers, colorants, pigments, nucleating agents such as talc, matifying agents such as titanium dioxide or zinc sulphide, processing aids, biocides, viscosity modifiers, cooling agents, catalysts, Far Infrared Rays emitting minerals, anti-static additives, functional additives, optical brightening agents, nanocapsules, anti-bacterial, anti-mite, anti-fungi or other conventional additives.

Generally, the amount of additives in the fiber represents up to 25% by weight, more preferably up to 10% by weight, based on the total weight of the fiber.

The polyamide in the polyamide article may be an aliphatic polyamide composed of AB and/or AABB type, selected from the group consisting of polyamide 6, polyamide 6.6, polyamide 6.9, polyamide 6.12, polyamide 6.10, polyamide 11, polyamide 12, polyamide 10.10, polyamide 4.6, polyamide 4.10, polyamide 12.12, polyamide 10.12 and mixtures thereof.

The above polyamides are well known in the art and can be obtained by polycondensation of a mixture of diacids and diamines monomers or a salt thereof, which are commercially available. The diamines and diacids of polyamide AABB type belong to the group of tetramethylenediamine (1,4-diaminobutane or putrescine), hexamethylenediamine (1,6-hexanediamine), dodecamethylenediamine (1,12-diaminododecane), hexanedioic acid (adipic acid), nonanedioic acid (azelaic acid), decanedioic acid (sebacic acid), undecanedioic acid, dodecanedioic acid. The monomers of the polyamide AB type belong to the group of caprolactam, 11-aminoundecanoamide, dodecanolactam or laurolactam.

In addition, polyamide may be a polyamide 5.X, X being an integer from 4 to 16 and mixtures thereof. More preferably, the polyamide fiber is an odd/even polyamide such as polyamide 5.4, 5.6, 5.8, 5.10, 5.12, 5.14.

Polyamide 5.X is made of pentamethylenediamine and an aliphatic dicarboxylic acid(s) as raw materials.

The list of potential dicarboxylic acids is the following: butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, brassylic acid, tetradecanedioic acid, pentadecanedioic acid, hexadecanedioic acid.

All those diacids are commercially available.

Polyamides 5.6 and 5.10 have the advantage of being able to be manufactured from biomass according to ASTM6866. As pentamethylenediamine can also be prepared from bio-resources according to ASTM6866, the resulting polyamide can be at least 45% bio-sourced and up to 100% from bio-resources.

Polyamide 5.6 is also known as poly(pentamethylene adipamide), which consists of pentamethylenediamine and adipic acid as raw materials. In a particular preferred embodiment, the polyamide in the polyamide article is selected from polyamide 6, polyamide 6.6, polyamide 5.6 and mixtures thereof.

In accordance with the present invention, the polyamide article can be submitted to a treatment before and/or after the at least one polyurethane depolymerization step. Typically, such a treatment provides standardization of waste conditions, and/or as reduction on surface tension.

In one embodiment, the process according to the invention further comprises at least one washing step of the polyamide article. The at least one washing step can be carried out before and/or after the at least one polyurethane depolymerization step.

In a particular embodiment, the washing step comprises contacting the polyamide article with a solution containing at least one solvent selected from aliphatic alcohols containing C1-C3 carbon chain or a glycerol ketal or a combination of water and at least one surfactant. Such a solution will be denoted the “washing solution” thereafter. The washing step employing the washing solution can be performed before the polyurethane depolymerization step, after the polyurethane depolymerization step or before and after the polyurethane depolymerization step.

According to one embodiment, the process according to the present invention, is particularly effective when the contact of the polyamide article with the washing solution is performed by having greater amount of such solution in comparison with the polyamide article amount. In particular, the washing solution may be used in the form of a bath in which the polyamide article is immersed; the amount of washing solution is preferably chosen so as to cover the polyamide article, preferably without letting any part of the polyamide article uncovered with the washing solution.

Particularly, when the washing step is performed before the depolymerization step, the polyamide article may be contacted with a washing solution containing water and at least one surfactant.

Particularly, when the washing step is performed after the depolymerization step, the polyamide article may be contacted with a washing solution containing at least one solvent selected from aliphatic alcohols containing C1-C3 carbon chain or a glycerol ketal or a combination of water and at least one surfactant. More particularly, this washing solution preferably comprises at least one solvent selected from aliphatic alcohols containing C1-C3 carbon chain or a glycerol ketal. Even more particularly, this washing solution may contain at least one solvent selected from aliphatic alcohols containing C1-C3 carbon chain or a glycerol ketal selected from solketal, 2-isobutyl-2-methyl-1,3-dioxolane-4-methanol; 2,2-dimethyl-1,3-dioxolane-4-acetate; 2,2-diisobutyl-1,3-dioxolane-4-methanol or mixtures thereof. Preferably, the solvent is ethanol or solketal. Particularly, solketal is a solvent commercially available, for example under the name Augeo® Clean Multi or Augeo® SL191 by Solvay. The surfactant that can be implemented in the washing step is generally selected in the group consisting of anionic, cationic, non-ionic and amphoteric surfactants.

Typically, anionic surfactants that are useful comprise carboxylic acid salts, alkylbenzene sulfonates, alkylbenzenesulfonic acid, secondary nalkanesulfonates, α-olefin sulfonates, dialkyl oxydiphenylene sulfonates, sulfosuccinate esters, isethionates, linear alcohol sulfates such as alkyl sulfates, for instance sodium lauryl sulfate, linear ethoxyalcohol sulfates and watersoluble salts of alkylbenzene sulfonates. Mixtures of two or more of the above can be used. All those surfactants are commercially available.

The cationic surfactants that are useful comprise primary amine salts, diamine salts, quaternary ammonium salts and ethoxylated amines. Mixtures of two or more above can be used. All those surfactants are commercially available.

The appropriate non-ionic surfactants comprise linear and branched alcohol ethoxylates, alkylamine oxides, for example C8-20 alkyldimethylamine oxides, alkylphenol ethoxylates, carboxylic acid esters, alkanolamides, alkylpolyglycosides, copolymers of ethylene oxide/propylene oxide, etc. Mixtures of two or more above surfactants can be used. All those surfactants are commercially available.

The preferred surfactant is non-ionic surfactants selected from linear and branched alcohol ethoxylates. Among these surfactants, linear and secondary alcohol ethoxylates, octylphenol and nonylphenol ethoxylates are particularly preferred. As suitable surfactant belonging to the category of non-ionic surfactants selected from linear and branched alcohol ethoxylates, mention can be made of Ekonova® EM0605.

In the process according to the invention, when the washing solution comprises a combination of water and at least one surfactant, the surfactant may be comprised from 0.5 to 10 g/L, preferably from 1.0 to 5 g/L of surfactant relative to the total volume of water.

In one embodiment, the washing step is performed at a temperature above 50° C. In a particular preferred embodiment, the washing step is performed at a temperature above 85° C. It may notably range from 50° C. to 110° C., in particular from 85° C. to 100° C.

A polyamide article that may need to be treated by the process of the invention can be colored by the presence therein of dyes. The process of the invention is all the more useful that it efficiently removes dyes from a polyamide article containing polyurethane fibers with a good yield in terms of recycled polyamide.

Accordingly, in one embodiment, the process according to the present invention further comprises the removal of dyes from the polyamide article. In other words, when the initial polyamide article comprises dyes, through the implementation of the process, dyes are at least partially removed from said polyamide article.

Particularly, the process of the present invention promoted the removal of more than 60 wt % of dyes, preferably more than 75 wt % of dyes based on the total weight of polyamide article.

The present invention also relates to a detailed process for removing polyurethane fibers from polyamide articles, comprising at least the following steps:
a1. providing a polyamide article comprising polyurethane fibers, and, optionally, dyes, and optionally pre-washing said article by contacting it with a solution containing water and at least one surfactant;
a2. submitting the optionally pre-washed polyamide article to at least one polyurethane fiber depolymerization process comprising at least one step of contacting said article with at least one solvent, and;
a3. post-washing the polyamide article from step a2 by contacting said article with a solution containing at least one solvent selected from aliphatic alcohols containing C1-C3 carbon chain or a glycerol ketal or a combination of water and at least one surfactant to remove the depolymerized polyurethane fibers.

Advantageously, the amount of polyurethane fibers removed from the polyamide article recovered from step a3 is of at least 87%, preferably of at least 90 wt %, preferably of at least 95 wt %, based on the weight of the polyurethane fibers in the polyamide article initially provided in step a1.

Advantageously, the amount of dyes removed from the polyamide article recovered from step a3 is of at least 60 wt %, in particular of at least 75 wt %, relatively to the amount of dyes in the polyamide article initially provided in step a1.

As mentioned above, optional washing step a1. is preferably performed using a solution comprising a combination of water and at least one surfactant.

Step a3. is preferably performed using a solution comprising at least one solvent selected from aliphatic alcohols containing C1-C3 carbon chain or a glycerol ketal or a combination of water and at least one surfactant.

The solution, either for step a1 or for step a3, is preferably used in greater amount than the polyamide article amount. In particular, the solution for either washing steps may be used in the form of a bath, preferably so as to completely cover the polyamide article, preferably without any part of the polyamide article let uncovered with the solution.

The depolymerization step can be carried out one or several times, in particular twice.

The washing step can be carried out one or several times, in particular twice. When it is conducted several times, the washing solution used the first time can be a washing solution totally or partially recycled; notably this first washing solution can comprise or consist of a washing solution that was used and recovered from the implementation of a former washing step. It can be eventually completed with fresh washing solution.

Generally, the process according to the invention allows recovery of polyamide fibers having high purity able of being recycled by additional depolymerization and repolymerization using common and usual processes known by a skilled person in the art.

As used herein, the “recovered polyamide fibers” are mainly the high pure polyamide fibers recovered from polyamide articles comprising a combination of polyamide and polyurethane fibers as described above.

The above description of the method of the invention also applies to the use according to the invention.

Should the disclosure of any patents, patent applications, and publications which are incorporated herein by reference conflict with the description of the present application to the extent that it may render a term unclear, the present description shall take precedence.

Other details or advantages of the invention will emerge more clearly in the light of the experimental section given below, purely for indicative purposes.

### EXAMPLES

A series of polyamide articles were formed and evaluated for polyurethane reduction evaluation and for dyes quantification if applicable.

For use in the PU depolymerization tests, textile samples of seamless knitted fabrics produced in a single-jersey circular machine, using textured polyamide 6,6 yarns (8 feeds), blended in the knitting machine with polyurethane yarns (8 feeds), were produced. Depending on the sample, the polyurethane percentage ratio on the basis of the total weight of polyurethane and polyamide ranged between 10 wt % and 21 wt %.

Dyed textile samples for use in the PU depolymerization tests were prepared in the same manner except that in addition, a predetermined amount of dye was added (amount indicated in the example 6), according to the dyeing methodology described in the item 2.1.

The following chemicals were used in the examples.

Ekonova® EM0605—C10-C13 fatty alcohol ethoxylates non-ionic surfactant, supplier Ekonova.

Sodium hydroxide, NaOH, PA ACS grade, molecular weight 40 g/mol, supplier Anidrol.

Ethanol, C2H60, purity between 95.1 and 96%, molecular weight 46.07 g/mol, supplier Anidrol.

### Method 1: Polyurethane Quantification in the Polyamide and Polyurethane Fabrics

This method describes how to quantify the content of polyurethane in polyamide and polyurethane fabrics. It is to be used to determine the initial PU content (prior to the process of polyurethane removal), and the final polyurethane content (after the process of polyurethane removal) in the polyamide and polyurethane fabrics.

The sample of the polyamide and polyurethane fabric is dried in an oven at 65° C. for 2 hours to remove any trace of moisture and weighted (weight noted M0). It is then placed in a beaker with cyclohexanone until covering the sample. The content is boiled for 10 minutes, cooled at room temperature, washed three times with ethanol to remove residual polyurethane and dried in an oven at 65° C. for 2 hours. The sample is then weighed again (weight noted M1). The amount of polyurethane fibers in the polyamide fabric is quantified by mass difference (M0−M1).

The percentage in weight (wt %) of polyurethane content in the polyamide and polyurethane fabric is expressed as: PU content (%)=(M0−M1)/M0×100.

For each of the examples, the removal rate of polyurethane in percentage is calculated by:

$$PU removal rate ( \% ) = ( PU content initial - PU content final / PU content initial \times 100$$

$$PU content initial = PU content prior to the polyurethane removal process PU content final = PU content after the polyurethane removal process$$

### Method 2: Dyeing Process and Dyes Quantification in the Polyamide and Polyurethane Fabric Before and After Polyurethane Depolymerization Treatment

2.1 Dyeing methodology: the fabrics are dyed in an exhausting equipment with a bath relation of 1:30 (1 part of fabric per 30 parts of water), at a temperature of 98° C. for 60 minutes, with 0.5 g/L of acetic acid 55%, 2 g/L of ammonium sulfate, 1% in total weight of the fabric of leveling agent, and an acid blue dye (Nylosan Azul Marinho N-RBL p 220 from Archroma) in an specific concentration, according to the desired color shade, calculated based on the weight of the PA fibers. The acid dye becomes chemically bonded to the amino groups of the polyamide, but is not linked to the polyurethane.

2.2 Reference scale setting up: for the dye quantification method, a reference scale was built, based on 15 textile samples. These samples of seamless knitted fabrics were produced in a single-jersey circular machine, using textured polyamide 6,6 yarns (16 feeds), and each of them was dyed with a different amount of dye (ranging from 0.05% to 3.5% in weight of PA fibers).

Accordingly, each sample was submitted to 6 lightness measurements according to the CIELAB color space measurements in a HunterLab ColorFlex Spectrocolorimeter. The lightness coordinate “L*” ranges from 0 to 100, with 0 and 100 representing black and white, respectively. With the obtained lightness values, a quadratic equation was built to describe the correlation between dye concentration and lightness. The concentration of dye is always in relation to the polyamide only.

2.3 Determination of the dye concentration in a polyamide and polyurethane sample: to estimate the amount of dyes in a dyed polyamide and polyurethane sample, triplicate lightness measurements are made on this sample using the same spectrocolorimeter. The resulting average lightness value is then compared to the aforementioned scale to estimate the equivalent dye concentration in weight of PA fibers in the polyamide and polyurethane sample.

The dye concentration (DC) in a dyed polyamide and polyurethane sample is determined in this way prior to the polyurethane removal process (DCinitial) and after the polyurethane removal process (DCfinal).

The dye removal rate is defined as:

$$Dyes removal rate ( \% ) = ( DCinitial - DCfinal ) / DCinitial \times 100$$

### Example A1: Depolymerization Steps a2 and a2′

A textile of polyamide containing 21% wt of polyurethane fibers relative to the total weight of the textile was provided.

Depolymerization step a2: Sample thereof A1 was placed in a bath containing ethanol in a ratio 1:30 (textile mass in kg to ethanol volume in L) and 30 wt % of sodium hydroxide (w/w textile). The system was heated at 100° C. for 15 min in an oven with a rotational system of 40 rpm.

Sample 1 was submitted to the same procedure (a2′) a second time in a new bath having the same composition. Sample A1 was recovered and the bath was disposed of.

Sample A1 was then solubilized into cyclohexanone in accordance with the method 1 detailed above in order to quantify residual polyurethane. The PU removal rate from sample A1 was of 94.76 wt % relative to the total amount of polyurethane present initially in the sample (before step a2).

### Example A2: Pre-Washing Step a1+Single Depolymerization Step a2

Pre-washing step a1: a textile of polyamide containing 21% wt of polyurethane fibers relative to the total weight of the textile was provided. Sample thereof A2 was submitted to a pretreatment bath containing water, in a ratio of 1:30 (textile mass in kg to solvent volume in L) and 1 g/L of surfactant Ekonova® EM0605 relative to the total volume of water. The system was placed in an oven with a rotational system of 40 rpm and heated at 90° C. for 20 min.

Depolymerization step a2: the pre-washed sample A2 was placed in a bath containing ethanol in a ratio 1:30 (textile mass in kg to solvent volume in L) and 30 wt % of sodium hydroxide (w/w textile). The system was heated at 100° C. for 15 min in an oven with a rotational system of 40 rpm.

The sample A2 was then solubilized into cyclohexanone in accordance with the method 1 detailed above in order to quantify residual polyurethane. The PU removal rate from sample A2 was of 93.57 wt % relative to the total amount of polyurethane present initially (before steps a1+a2) in the sample.

### Example 1: Pre-Washing Step a1+Depolymerization Steps a2 and a2′+Post-Washing a3 in Water and Surfactant

Pre-washing step a1: in step a1, sample 1 of polyamide textile containing 21% wt of polyurethane fibers relative to the total weight of the textile was placed into a reactor containing water in a ratio 1:30 (textile mass in kg to solvent volume in L) and 1 g/L of Ekonova® EM0605 relative to the total volume of water. The system was placed in an oven with a rotational system of 40 rpm. The system was heated at 90° C. for 20 min. After, the bath was disposed of and the textile proceeded to the depolymerization process a2.

Depolymerization step a2: the pretreated sample 1 was placed into a bath containing ethanol in a ratio 1:30 (textile mass in kg to solvent volume in L), and 30 wt % of sodium hydroxide (w/w textile). The reactor was heated at 100° C. for 15 min in an oven with a rotational system of 40 rpm. Sample 1 was recovered and the bath was disposed of.

Depolymerization step a2′: sample 1 was submitted to procedure of step a2 a second time in a new bath having the same composition. Sample 1 was recovered and the bath was disposed of.

Post-washing step a3: sample 1 was then submitted to the same process as described in step a1, in order to remove the residual polyurethane from the fabric surface.

Sample 1 was then solubilized into cyclohexanone in order to quantify residual polyurethane in accordance with the methodology explained above: The PU removal rate from sample 1 was of 99.50 wt % relative to the total amount of polyurethane present initially (before steps a1+a2+a2′+a3) in the sample.

### Example 2: Change in the Solvent Ratio in the Depolymerization Step

Example 1 was repeated on a sample 2 of the same textile in the same conditions, except that the ethanol ratio in the depolymerization steps a2 and a2′ was of 1:10 (textile mass in kg to solvent volume in L) instead of 1:30.

The PU removal rate from sample 2 was of 99.60 wt % relative to the total amount of polyurethane present initially (before steps a1+a2+a2′+a3) in the sample.

### Example 3: Pre-Washing Step a1+Depolymerization Step a2+Post-Washing a3 in Ethanol

A textile of polyamide containing 17% wt of polyurethane fibers relative to the total weight of the textile was provided.

Pre-washing step a1: a sample 3 of the polyamide textile was placed into a reactor containing water in a ratio 1:30 (textile mass in kg to solvent volume in L) and 1 g/L of Ekonova® EM0605 relative to the total volume of water. The system was placed in an oven with a rotational system of 40 rpm. The system was heated at 90° C. for 20 min. After, the bath was disposed of and the textile proceeded to the depolymerization process.

Depolymerization step a2: sample 3 was placed into a bath containing ethanol in a ratio of 1:30 (textile mass in kg to solvent volume in L) with 30 wt % of sodium hydroxide (w/w textile). The reactor was heated at 100° C. for 60 min in an oven with a rotational system of 40 rpm. Textile sample 3 then proceeded to post washing treatment.

Post-washing step a3: sample 3 was then treated with ethanol in a ratio 1:30 (textile mass in kg to solvent volume in L), for 20 minutes at 80° C., with an agitation system of 40 rpm, in order to remove the residual polyurethane from the fabric surface.

Sample 3 was then solubilized into cyclohexanone in order to quantify polyurethane reduction for sample 3, in accordance with the methodology explained above: The PU removal rate from sample 3 was of 98.82 wt % relative to the total amount of polyurethane present initially (before steps a1+a2+a3) in the sample.

### Example 4: Change in Initial PU Amount and in Heat Treatment Time in the Depolymerization Step

Example 3 was repeated except that a textile of polyamide containing 21% wt of polyurethane fibers relative to the total weight of the textile was used (instead of 17% wt) and that in step a2, the reactor was heated at 100° C. for 15 min (instead of 60 min).

The PU removal rate from sample 4 was of 97.70 wt % relative to the total amount of polyurethane present initially (before steps a1+a2+a3) in the sample.

### Example 5: Depolymerization Steps a2 and a2′+Post-Washing a3 with a Combination of Water and a Surfactant

A textile of polyamide containing 21% wt of polyurethane fibers relative to the total weight of the textile was provided.

Depolymerization step a2: a sample 5 of the textile was placed into a bath containing ethanol in a ratio of 1:30 (textile mass in kg to solvent volume in L) with 30% of sodium hydroxide (w/w textile). The reactor was heated at 100° C. for 15 min in an oven with a rotational system of 40 rpm. Textile sample 5 was then proceeded to the second stage of depolymerization, step a2′.

Depolymerization step a2′: sample 5 was placed into a bath containing ethanol in a ratio of 1:10 (textile mass in kg to solvent volume in L), with 30% of sodium hydroxide (w/w textile). The reactor was heated at 100° C. for 15 min in an oven with a rotational system 40 rpm. Textile sample 5 then proceeded to the post washing treatment.

Post-washing step a3: Sample 5 was placed into a reactor containing water in a ratio of 1:30 (textile mass in kg to solvent volume in L) and 1 g/L of Ekonova® EM0605 relative to the total volume of water. The system was placed in an oven with a rotational system of 40 rpm. The system was heated at 90° C. for 20 min.

Sample 5 was then solubilized into cyclohexanone in order to quantify polyurethane reduction for sample 5, in accordance with the methodology explained above: The PU removal rate from sample 5 was of 98.05 wt % relative to the total amount of polyurethane present initially (before steps a2+a2′+a3) in the sample.

### Example 6: Depolymerization and Dyes Removal Steps a2 and a2′+Postwashings a3 and a3′ Using Recycled Ethanol

A textile of polyamide containing 17% of polyurethane fibers relative to the total weight of the textile and 4.4% of dye relative to the total weight of the PA fibers was provided.

Depolymerization step a2: a sample of said textile was placed into a bath containing a solvent in a ratio 1:10 (textile mass in kg to solvent volume in L) and 30% of sodium hydroxide (w/w textile). The solvent was composed of 60 wt % of fresh ethanol and 40 wt % of a reused solution of ethanol. The reused solution of ethanol was obtained from the implementation of a first post-washing step a3, using only fresh ethanol as solvent, in a similar process. The reactor was heated at 100° C. for 15 min in an oven with a rotational system of 40 rpm. Textile sample 6 was then proceeded to the first post washing treatment step a3.

First post-washing step a3: sample 6 was placed into a reactor containing ethanol in a ratio of 1:10 (textile mass in kg to solvent volume in L). The solvent was composed of 60 wt % of fresh ethanol and 40 wt % of a reused solution of ethanol. The reused solution of ethanol was obtained from a second post-washing process a3′ using only fresh ethanol as solvent, in a similar process. The system was placed in an oven with a rotational system of 40 rpm. The system was heated at 80° C. for 20 min. Textile sample 6 then proceeded to the second post washing treatment, step a3′.

Second post-washing step a3′: sample 6 was then submitted to a second post washing process. Sample 6 was placed in a reactor containing fresh ethanol in a ratio of 1:10 (textile mass in kg to solvent volume in L). The system was placed in an oven with a rotational system of 40 rpm. The system was heated at 80° C. for 20 min.

The dyes removal quantification was performed following the protocol depicted in method 2 above. The dyes removal rate from sample 6 was of 75.84 wt % relative to the initial dye concentration in the sample (before steps a2+a3+a3′).

Sample 6 was solubilized into cyclohexanone in order to quantify polyurethane reduction in accordance with method 1 depicted above. The PU removal rate from sample 6 was of 87.35 wt % relative to the total amount of polyurethane present initially in the sample (before steps a2+a3+a3′).

### Example 7: Example with KOH as Catalyst—Depolymerization Steps a2′+Post-Washing a3 and a3′ in Ethanol

A textile of polyamide containing 10% wt of polyurethane fibers relative to the total weight of the textile and 2% of dye relative to the total weight of the PA fibers was provided.

Depolymerization step a2: a sample thereof (hereafter sample 7) was placed into a bath containing ethanol in a ratio of 1:20 (textile mass in kg to solvent volume in L) with 25 wt % of potassium hydroxide (w/w textile). The reactor was heated at 100° C. for 15 min in an oven with a rotational system of 40 rpm. Textile sample 7 then proceeded to depolymerization step a2′.

Post-washing step a3: sample 7 was then treated with ethanol in a ratio 1:20 (textile mass in kg to solvent volume in L), for 15 minutes at 100° C., with an agitation system of 40 rpm, in order to remove the residual polyurethane from the fabric surface.

Post-washing step a3′: sample 7 was then submitted to a second post washing process. Sample 7 was placed in a reactor containing fresh ethanol in a ratio of 1:20 (textile mass in kg to solvent volume in L). The system was placed in an oven with a rotational system of 40 rpm. The system was heated at 100° C. for 20 min.

Sample 7 was then solubilized into cyclohexanone in order to quantify polyurethane reduction for sample 7, in accordance with the methodology explained above: The PU removal rate from sample 7 was of 97.80 wt % relative to the total amount of polyurethane present initially (before steps a2+a3+a3′) in the sample.

The dyes removal quantification was performed following the protocol depicted in method 2 above. The dyes removal rate from sample 7 was of 97.37 wt % relative to the initial dye concentration in the sample (before steps a2+a3+a3′).

### Example 8: Example with NaOH as Catalyst and the Same Steps as in Example 7—Depolymerization Steps a2′+Post-Washing a3 and a3′ in Ethanol

A textile of polyamide containing 10% wt of polyurethane fibers relative to the total weight of the textile and 2% of dye relative to the total weight of the PA fibers was provided.

Depolymerization step a2: sample thereof (hereafter sample 8) was placed into a bath containing ethanol in a ratio of 1:20 (textile mass in kg to solvent volume in L) with 25 wt % of sodium hydroxide (w/w textile). The reactor was heated at 100° C. for 15 min in an oven with a rotational system of 40 rpm. Textile sample 7 then proceeded to post-washing step a3.

Post-washing step a3: sample 8 was then treated with ethanol in a ratio 1:20 (textile mass in kg to solvent volume in L), for 15 minutes at 100° C., with an agitation system of 40 rpm, in order to remove the residual polyurethane from the fabric surface.

Post-washing step a3′: sample 8 was then submitted to a second post washing process. Sample 8 was placed in a reactor containing fresh ethanol in a ratio of 1:20 (textile mass in kg to solvent volume in L). The system was placed in an oven with a rotational system of 40 rpm. The system was heated at 100° C. for 20 min.

Sample 8 was then solubilized into cyclohexanone in order to quantify polyurethane reduction for sample 7, in accordance with the methodology explained above: The PU removal rate from sample 7 was of 95.20 wt % relative to the total amount of polyurethane present initially (before steps a2+a3+a3′) in the sample.

The dyes removal quantification was performed following the protocol depicted in method 2 above. The dyes removal rate from sample 7 was of 94.74 wt % relative to the initial dye concentration in the sample (before steps a2+a3+a3′).

### Example 9: Example without Catalyst

A textile of polyamide containing 10% wt of polyurethane fibers relative to the total weight of the textile and 2% of dye relative to the total weight of the PA fibers was provided.

Depolymerization step a2 (without catalyst): a sample thereof (hereafter sample 9) was placed into a bath containing ethanol in a ratio of 1:20 (textile mass in kg to solvent volume in L) without catalyst. The reactor was heated at 100° C. for 15 min in an oven with a rotational system of 40 rpm. Textile sample 9 then proceeded to post-washing step a3.

Post-washing step a3: sample 9 was then treated with ethanol in a ratio 1:20 (textile mass in kg to solvent volume in L), for 15 minutes at 100° C., with an agitation system of 40 rpm.

Post-washing step a3′: sample 9 was then submitted to a second post washing process. Sample 9 was placed in a reactor containing fresh ethanol in a ratio of 1:20 (textile mass in kg to solvent volume in L). The system was placed in an oven with a rotational system of 40 rpm. The system was heated at 100° C. for 20 min.

Sample 9 was then solubilized into cyclohexanone in order to quantify polyurethane reduction for sample 9, in accordance with the methodology explained above.

Even without the use of a catalyst a PU removal was observed. The PU removal from sample 9 was observed relative to the total amount of polyurethane present initially (before steps a2+a3+a3′) in the sample.

The dyes removal quantification was performed following the protocol depicted in method 2 above. The dyes removal rate from sample 8 was of 1.05 wt % relative to the initial dye concentration in the sample (before steps a2+a3+a3′).

### Example 10: Example without Catalyst and with Solvent ACM

A textile of polyamide containing 7.5 wt % of polyurethane fibers relative to the total weight of the textile was provided.

Depolymerization step a2: a sample thereof (hereafter sample 10) was placed in a bath containing Augeo Clean Multi (ACM) in a ratio 1:30 (textile mass in kg to solvent volume in L). The system was heated at 150° C. for 7 hours in a jacket reactor with mechanical stirring of 300 rpm. The textile sample 10 then proceeded to post-washing step a3.

Post-washing step a3: Sample 10 was then submitted to the post washing process. The textile was placed into a jacket reactor containing water in a ratio 1:30 (textile mass in kg to solvent volume in L) with mechanical stirring of 300 rpm. The system was heated at 60° C. for 30 min. After, the bath was disposed of and the textile proceeded to be analyzed.

PU removal from sample 10 was significant relative to the total amount of polyurethane present initially.

The polyurethane quantification methodology used in this example was the following:

In order to quantify polyurethane removal for sample 10, the sample was dried at 105° C. for 24 hours to remove any trace of moisture and after weighted (M0). The textile was then placed into a becker with dimethylacetamide until it covered the sample. The content was heated at 60 DC for 1 hour, washed with acetone to remove residual polyurethane, dried at 105° C. for 24 hours and weighed again (M1). The polyurethane removal rate was calculated by the mass difference of the initial and final sample: PU content ((M0−M1)/M0×100.

### Results

Table 1 summarizes polyurethane removal rate of each sample and when appropriate the dyes removal rate therefrom. The results show that, despite the fact that dyes are generally considered as hindering the recycling of a polymeric textile, a polyurethane removal rate of at least 87, 35 wt % could be achieved when dyes were present in the initial polyamide textile. A polyurethane removal rate of at least 93.57 wt % could even be achieved when no dyes were present.

TABLE 1
polyurethane removal rate and dyes removal
rate in the different samples

| | PU removal | Dyes removal |
|---|---|---|
| Example | rate (%) | rate (%) |
| A1 | 94.76 | NA |
| A2 | 93.57 | NA |
| 1 | 99.50 | NA |
| 2 | 99.60 | NA |
| 3 | 98.82 | NA |
| 4 | 97.70 | NA |
| 5 | 98.05 | NA |
| 6 | 87.35 | 75.84 |
| 7 | 97.80 | 97.37 |
| 8 | 95.20 | 94.74 |

Therefore, it was demonstrated a process able to remove most of the polyurethane present in a polyamide article containing polyamide fibers by selective depolymerization of polyurethane using a mild and sustainable process.

It was also demonstrated that recycling of high purity polyamide fibers is possible since large amounts of polyamide was recovered from polyamide articles containing polyurethane fibers.

Furthermore, it was demonstrated that polyurethane and dyes can be removed from a polyamide article containing polyamide fibers in the presence of different solvents and even without the use of a catalyst.

In addition, it was demonstrated that the same process was able to quantitively remove the dyes present in a polyamide article containing polyurethane fibers: using a single process to remove both the polyurethane fibers and the dyes from a polyamide article is consequently a step forward to improve the efficiency of a polyamide article recycling process at industrial scale.

1. A process for removing polyurethane fibers from a polyamide article, comprising at least one step of depolymerization of the polyurethane fibers carried out by contacting said article with at least one solvent.

2. The process of claim 1, wherein the depolymerization step is carried out in the presence of at least one catalyst.

3. The process of claim 2, wherein the catalyst is selected from hydroxy base compounds and acids.

4. The process of claim 2, wherein the catalyst is selected from sodium hydroxide, potassium hydroxide, phosphoric acid, boric acid, sulfuric acid, organic acids, organic sulfonic acids, solid acids, and salts thereof.

5. The process of claim 2, wherein the catalyst is a base consisting of sodium hydroxide.

6. The process of claim 1, wherein the solvent is a polar solvent selected from aliphatic alcohols containing C1-C3 carbon chain or a glycerol ketal selected from solketal, 2-isobutyl-2-methyl-1,3 dioxolane-4-methanol; 2,2-dimethyl-1,3-dioxolane-4-acetate; 2,2-diisobutyl-1,3-dioxolane-4-methanol or mixtures thereof.

7. The process of claim 6, wherein the solvent is ethanol or solketal.

8. The process of claim 1, wherein the ratio of polyamide article:solvent is selected from 1:5 to 1:100, in terms of article mass in kg to solvent volume in L.

9. The process of claim 1, wherein the depolymerization step is performed at a temperature above 80° C.

10. The process of claim 1, wherein the polyamide article is selected from polyamide textiles, yarns and fibers.

11. The process of claim 1, wherein the polyamide in the polyamide article is selected from polyamide 6, polyamide 6.6, polyamide 5.6 and mixtures thereof.

12. The process of claim 1, further comprising at least one washing step of the polyamide article.

13. The process of claim 12, wherein the at least one washing step is performed before the polyurethane depolymerization step, after the polyurethane depolymerization step or before and after the polyurethane depolymerization step.

14. The process of claim 12, wherein the at least one washing step comprises contacting the polyamide article with a solution containing at least one solvent selected from aliphatic alcohols containing C1-C3 carbon chain or a glycerol ketal or a combination of water and at least one surfactant.

15. The process of claim 14, wherein the surfactant is a non-ionic surfactant selected from linear and branched alcohol ethoxylates.

16. The process of claim 12, wherein the at least one washing step is performed at a temperature above 50° C.

17. The process of claim 1, wherein the polyamide article to be subjected to said process comprises dyes and through the implementation of which the dyes are at least partially removed from said polyamide article.

18. A process for removing polyurethane fibers from a polyamide article comprising at least the following steps:
a1. providing a polyamide article comprising polyurethane fibers and, optionally, dyes, and optionally pre-washing said article by contacting it with a solution comprising water and at least one surfactant;
a2. submitting the optionally pre-washed polyamide article to at least one polyurethane fibers depolymerization process comprising at least one step of contacting said article with at least one solvent, and;
a3. post-washing the polyamide article from step a2 by contacting said article with a solution comprising at least one solvent selected from aliphatic alcohols containing C1-C3 carbon chain or a glycerol ketal or a combination of water and at least one surfactant to remove the depolymerized polyurethane fibers.

19. The process according to claim 18, wherein the amount of polyurethane fibers removed from the polyamide article recovered from step a3 is of at least 87%, relatively to the amount of polyurethane fibers in the polyamide article initially provided in step a1.

20. The process according to claim 18, wherein the amount of dyes removed from the polyamide article recovered from step a3 is of at least 60 wt %, in particular of at least 75 wt %, relatively to the amount of dyes in the polyamide article initially provided in step a1.
